(19) United States
(12) Patent Application Publication
(10) Pub. No.: US 2013/0284480 A1
(43) Pub. Date: Oct. 31, 2013

(54) POWER TOOL

(71) Applicant: HITACHI KOKI CO., LTD., Tokyo (JP)

(72) Inventors: Yuki HORIE, Hitachinaka (JP); Nobuhiro TAKANO, Hitachinaka (JP); Kazuhiko FUNABASHI, Hitachinaka (JP); Tomomasa NISHIKAWA, Hitachinaka (JP); Yukihiro SHIMA, Hitachinaka (JP); Takao ARADACHI, Hitachinaka (JP)

(73) Assignee: HITACHI KOKI CO., LTD., Tokyo (JP)

(21) Appl. No.: 13/873,911

(22) Filed: Apr. 30, 2013

(30) Foreign Application Priority Data
Apr. 30, 2012 (JP) 2012-104290

(51) Int. Cl. B25F 5/00

(52) U.S. Cl. CPC B25F 5/00
USPC 173/217

(57) ABSTRACT

In a power tool including: a housing having a body portion which houses a motor and a handle portion extending downward from the body portion; an output portion driven at the front of the motor; and a trigger switch which controls power supply from a battery to the motor, the motor, the battery, and the trigger switch are arranged so as to overlap each other in an intersecting direction with respect to a front-and-rear direction.

### CROSS-REFERENCE TO RELATED APPLICATION

The present application claims priority from Japanese Patent Application No. 2012-104290 filed on Apr. 30, 2012, the content of which is hereby incorporated by reference into this application.

### TECHNICAL FIELD OF THE INVENTION

The present invention relates to a power tool which transmits a rotary force outputted from a motor using electricity accumulated in a battery as an energy source, transferred to a tip tool so as to perform such an operation as tightening, cutting, and boring.

### BACKGROUND OF THE INVENTION

A hand-held-type power tool, more particularly, a cordless-type power tool to be driven by electric energy accumulated in a battery is widely used. For a cordless power tool, while it is required to ensure a predetermined operation time and a predetermined output, downsizing is strongly desired. For example, Japanese Patent Application Laid-Open Publication No. 2008-270007 (Patent Document 1) discloses so-called gun-type power tool in which a motor and a power transmission mechanism are coaxially arranged inside a cylindrical body portion of a housing, and a battery is housed in a handle portion extending downward from the rear of the body portion. In a conventional power tool, a clutch mechanism which is the power transmission mechanism is housed inside the body portion of the housing. A motor, the power transmission mechanism, and an output shaft are aligned on the same axis line, and a circuit board is arranged at the rear of the motor. Also, a pack-type battery which is detachable from the power tool is used as a battery, and the battery is attached below the handle portion so as to protrude therefrom.

### SUMMARY OF THE INVENTION

When the pack-type battery which is detachable from the power tool is used as disclosed in the Patent Document 1, a power tool capable of easily replacing the battery and obtaining a predetermined tightening torque can be achieved. However, the heavy battery pack is attached below the handle portion. Therefore, in the power tool whose downsizing is pursued, further lightweight and further downsizing have been desired.

A preferred aim of the present invention is to achieve further downsizing and further light weight in a power tool.

The features of typical ones of the inventions disclosed in the present application will be briefly described as follows.

According to one feature of the present invention, a power tool includes: a housing having a body portion which houses a motor and a handle portion extending downward from the body portion; an output portion driven at the front of the motor; and a trigger switch which controls power supply from a battery to the motor. In an intersecting direction with respect to a front-and-rear direction, the motor, the battery, and the trigger switch are arranged so as to overlap each other. Therefore, a length of the power tool in the front-and-rear direction is shortened. For example, the battery and the trigger switch are arranged immediately below the motor inside the handle portion so as to be aligned in the front-and-rear direction. In this case, lengths of the power tool in the front-and-rear direction and in the intersecting direction (up-and-down direction) with respect to the front-and-rear direction are shortened. In the housing, a cylindrical body portion and the handle portion may be arranged so as to be coupled to each other in a substantially L shape in a side view. In this case, a power tool which is easily gripped and compact is achieved. Also, it is preferred that a length of the housing in the front-and-rear direction is equal to or shorter than 150 mm and a length thereof in the up-and-down direction is equal to or shorter than 90 mm. In this case, a power tool which is portable as being put in a pocket of working clothes is achieved.

According to another feature of the present invention, the output portion includes: a speed-reduction mechanism which reduces a speed of rotation of the motor; and an output shaft which holds a tip tool and is rotated by the speed-reduction mechanism. In this case, a high tightening torque can be obtained also by a motor with small output. The battery is preferably a lithium ion secondary battery having a diameter of 14 mm and a length of 50 mm in which continuous discharge is allowed at a current value equal to or larger than 20 A. In this case, a power tool which can have a small size and endure a high load work is achieved. One or more lithium ion secondary batteries are preferably housed in the handle portion. In this case, a power tool whose outer appearance is slim so as to be easily handled is achieved since a protruding portion for housing the batteries does not exist below the handle portion. If a rotating shaft of the motor is arranged coaxially with and in series to the output shaft, a compact power tool in which the battery is efficiently arranged below the motor so that a total height is suppressed is achieved. If the rotating shaft of the motor is arranged in parallel to the output shaft so that an axis line thereof is shifted from the output shaft, a power tool in which a front-and-rear length of the body portion of the housing is compact (short) is achieved.

According to the present invention, a motor, a battery, and a trigger switch are arranged so as to overlap each other in an intersecting direction with respect to a front-and-rear direction, and therefore, at least a length of the power tool in the front-and-rear direction is shortened.

The above and other preferred aims and novel characteristics of the present invention will be apparent from the description of the present specification and the accompanying drawings.

### BRIEF DESCRIPTIONS OF THE DRAWINGS

FIG. 1 is a vertical cross-sectional view illustrating an inner structure of a power tool (an impact driver 1) according to a first embodiment of the present invention;

FIG. 2 is a vertical cross-sectional view illustrating an inner structure of a power tool (an impact driver 101) according to a second embodiment of the present invention;

FIG. 3 is a diagram for explaining a relation between a battery volume and the maximum torque of the power tool in the first and second embodiments;

FIG. 4 is a vertical cross-sectional view illustrating an inner structure of a power tool (a driver drill 201) according to a third embodiment of the present invention; and

FIG. 5 is a diagram for explaining a relation between a battery volume and the maximum torque of the power tool in the third embodiment.

### DESCRIPTIONS OF THE PREFERRED EMBODIMENTS

### First Embodiment

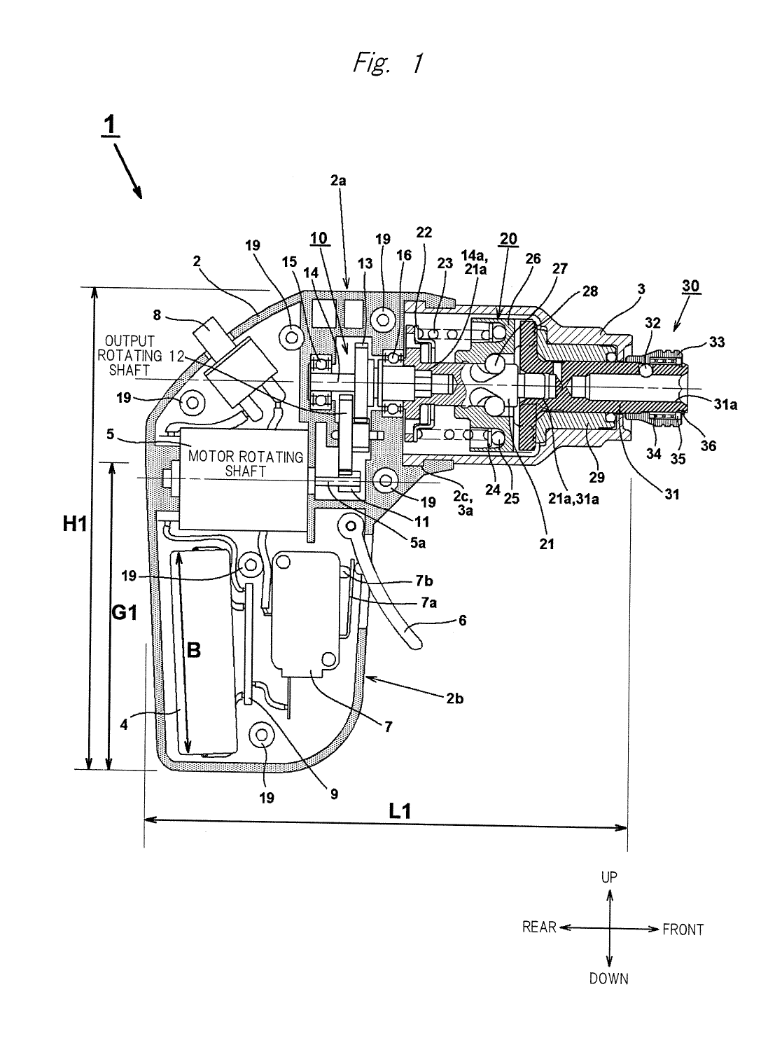

Hereinafter, embodiments of the present invention will be described based on the drawings. Note that the same components are denoted by the same reference symbols throughout the following drawings, and the repetitive description thereof will be omitted. Also in the present specification, front, rear, up, and down directions are explained as directions illustrated in the drawings. FIG. 1 is a diagram illustrating an inner structure of an impact driver 1 as an embodiment of a power tool according to the present invention.

A power supply of the impact driver 1 is a rechargeable battery 4, and a driving source thereof is a motor 5. In the impact driver 1, an impact mechanism 20 is driven through a speed-reduction mechanism 10 so as to apply a rotary force and an impact force to an output shaft 31. By applying the rotary force and the impact force to the output shaft 31, a rotary impact force is continuously or intermittently transmitted to such a tip tool as a driver bit not illustrated, so that such a work as screwing, bolting, and boring is performed. In the present embodiment, in order to minimize a size of the power tool, a shape of the housing is formed in a substantially L shape in a side view. A total length (a front-and-rear length) L1 of the impact driver 1 illustrated in FIG. 1 is equal to or shorter than 100 mm, and a total height H1 thereof is equal to or lower than 100 mm. The total height H1 is preferably equal to or lower than 90 mm. The housing is configured of: a housing main body 2 made of polymer resin such as plastic; and a hammer case 3 attached so as to protrude forward from the housing main body 2, and has an L shape (or a gun-type shape) in a side view. The speed-reduction mechanism 10, the impact mechanism 20, and others serving as the output portion are housed in a body portion which is a horizontal portion of the housing, and the battery 4 and a trigger switch 7 are mainly housed in a handle portion 2b which is a vertical portion thereof.

The motor 5 is a direct-current motor with a brush, and is rotated by electric energy supplied from the battery 4. In the present embodiment, a rotating shaft 5a of the motor 5 is arranged inside the housing main body 2 so as not to be on the coaxial with rotation axes (output rotation axes) of the impact mechanism 20 and the output shaft 31 but to be shifted downward therefrom. By taking such an arrangement mode of the motor 5, a second pinion 12 and a third pinion 13 can be arranged above a first pinion 11 provided on the rotating shaft 5a. Also, by appropriately setting the number of gears of the first pinion 11, the second pinion 12, and the third pinion 13, a speed-reduction mechanism that rotates a driving shaft 14 so as to reduce the number of revolutions of the motor 5 is reduced at a predetermined speed-reduction ratio can be achieved. At this time, the driving shaft 14 is held by two bearings 15 and 16 at the front and rear of the third pinion 13. Both of the bearings 15 and 16 are held by a solid portion (an integrally-molded synthesis resin portion) formed on an inner wall of the housing main body 2. However, the bearing 15 is arranged at a position not interfering with a cylindrical portion of the motor 5, and therefore, the motor 5 and the speed-reduction mechanism can be efficiently arranged inside the small-sized housing main body 2, and rigidity of the rotational driving system can be also enhanced. Further, the output shaft 31 and the rotating shaft 5a of the motor 5 are arranged so as not to be in series to each other but to be in the up-and-down direction. That is, the output shaft 31 and the rotating shaft 5a of the motor 5 are arranged so as not to be in series but to be in parallel to each other. Therefore, even within a limited housing dimension, a space for the bearings 15 and 16 can be sufficiently ensured. Thus, a ball bearing having a relatively large outer diameter can be used, and rigidity of the output rotation axis can be sufficiently enhanced.

A forward/reverse switch 8 for switching a rotating direction of the motor 5 is provided above the motor 5 and at the rear of the bearing 15. By operating the forward/reverse switch 8, the rotating direction of the motor 5 is switched between a forward rotating direction (a direction of tightening a screw or a bolt) and a reverse rotating direction (a direction of releasing the screw or the bolt). Note that the forward/reverse switch 8 is preferably a three-contact switch having a lock position (a position at which the motor 5 does not rotate even if a trigger 6 is pulled) in addition to a forward rotating position and a reverse rotating position.

The battery 4, the trigger switch 7, the trigger 6, and a circuit board 9 are housed in a lower portion of the motor 5 in the housing main body 2, that is, in the handle portion 2b. Immediately below the motor 5 inside the handle portion 2b, the battery 4 and the trigger switch 7 that controls power supply from the battery 4 to the motor 5 are arranged so as to be aligned in the front-and-rear direction. The battery 4 is, for example, a 14500-size lithium ion battery in which continuous discharge is allowed at a current value equal to or larger than 20 A. In the present embodiment, two lithium ion batteries are housed so as to be aligned in parallel to each other in a lateral direction (a right-and-left direction), and a rated voltage of the series connection is 7.2 V. In FIG. 1, since the batteries 4 arranged in parallel are viewed from an immediately lateral position, only one battery 4 appears. The 14500-size battery 4 has a battery length B of about 50 mm which is sufficiently shorter than a length “G1=70 mm” of the handle portion 2b gripped by a worker. Therefore, even if a space inside the handle portion 2b of the housing main body 2 is compressed by offsetting the motor 5 downward with respect to the output rotation axis, the sufficient space for housing the batteries 4 is ensured. Note that the number of batteries 4 for use is any number, and one to four batteries may be arranged in accordance with a necessary tightening torque of the output shaft 31, working duration time, or others. Also, the connection of the batteries 4 may be not only the series connection but also a parallel connection or a combination connection of the series connection and the parallel connection.

The trigger switch 7 is a limit switch with a lever 7a. When the trigger 6 is pulled by the worker, the lever 7a is pushed to move a plunger 7b, so that the trigger switch is turned to be in an ON state. Note that the trigger switch 7 in the present embodiment is a two-step speed change switch which is switchable between the ON state and an OFF state. However, a variable switch which can change a speed with the number of revolutions of the motor 5 at no step may be used, or a small-sized switch having other form may be used. Between the trigger switch 7 and the battery 4, the circuit board 9 is arranged in the vertical direction. The circuit board 9 has a control circuit mounted thereon, which monitors the battery 4 supplying the power to the motor 5 and interrupts the power supply to the motor 5 when temperature anomaly, overdischarge, or others occurs.

A hexagonal shaft 14a whose cross-sectional shape is hexagon is provided at a front end of the driving shaft 14, and is fitted in a hexagonal hole 21a provided at a rear end of a spindle 21. By such a connection state, the rotary force of the motor 5 is transmitted to the spindle 21 so that the spindle 21 is rotated at a predetermined speed. The spindle 21 and a hammer 26 are coupled to each other by a cam mechanism. This cam mechanism is configured of: a V-shaped spindle cam groove formed on an outer circumferential surface of the spindle 21; a hammer cam groove formed on an inner circumferential surface of the hammer 26; and a ball 27 arranged between these cam grooves.

The hammer 26 is always urged forward by a spring 23, and is at a position spaced from an end surface of an anvil 28 in a stationary state due to engagement of the ball 27 with the cam groove. A rear portion of the spring 23 is held by a pressing member 22, and a front portion thereof is held by a washer 24. An O ring 25 is interposed between a front side of the washer 24 and the hammer 26, so that vibration transmitted to the power tool in the impacting is reduced. At two positions on a rotary plane where the hammer 26 and the anvil 28 face each other, convex portions not illustrated are symmetrically formed, respectively. A distal end (a front end) of the output shaft 31, a one-touch attachment portion 30 is provided. The attachment portion 30 includes: the output shaft 31 provided with a hexagonal hole 31a whose cross-sectional surface is hexagon; a ball 32 movable in a radial direction inside the hexagonal hole 31a; and a sleeve 33 pressing an outer circumferential side of the ball 32. The sleeve 33 is movable frontward and backward along an axial direction of the output shaft 31, has a protruding portion formed thereon which regulates outward movement of the ball 32 in the radial direction, and is urged backward in the axial direction by a spring 34. A washer 35 is inserted on a front side of the spring 34, and the washer 35 is fixed by a retaining ring (a C-shaped washer) 36 fitted into an annular groove provided on the output shaft. By such a structure, the tip tool can be inserted into or drawn from the hexagonal hole 31a of the output shaft 31 as pulling the sleeve 33 forward in the axial direction.

When the spindle 21 is driven to be rotated, the rotation is transmitted through the cam mechanism to the hammer 26, and a convex portion of the hammer 26 is engaged with a convex portion of the anvil 28 before the hammer 26 is turned half round so as to rotate the anvil 28. When relative rotation is caused between the spindle 21 and the hammer 26 by engagement reaction force obtained at that time, the hammer 26 starts to recede onto a motor 5 side as pressing the spring 23 along the spindle cam groove of the cam mechanism.

And, the convex portion of the hammer 26 is laid over the convex portion of the anvil 28 by the receding movement of the hammer 26 so as to release the engagement therebetween, the hammer 26 is moved forward by the urging force of the spring 23 as being rapidly accelerated forward and in the rotating direction by elastic energy accumulated in the spring 23 and action of the cam mechanism in addition to the rotary force of the spindle 21, and the convex portion thereof is engaged with the convex portion of the anvil 28 again so as to be integrally rotated therewith. At this time, a strong rotatory impact force is applied to the anvil 28, and therefore, the rotatory impact force is transmitted to a member to be tightened such as a screw through the tip tool mounted on the output shaft integrally formed with the anvil 28 but not illustrated. Hereinafter, similar operations are repeated, so that the rotary impact force is intermittently and repeatedly transmitted from the tip tool to the member to be tightened.

The output shaft 31 is held so as to be rotated by a metal (slide bearing) 29 arranged on an inner circumferential surface of the hammer case 3. The housing main body 2 is manufactured so as to be dividable in the right-and-left direction on a vertical plane passing through the output rotation axis. The hammer case 3 with the substantially cylindrical shape is fixed by a state that a rib 3a formed at a rear end of the hammer case is inserted into a groove portion 2c continuously formed on an inner circumferential portion of the housing main body 2 in a circumferential direction. FIG. 1 illustrates a state of a left housing of the housing main body 2, and a plurality of screw bosses 19 are formed in the housing main body 2. A right housing (not illustrated) of the housing main body 2 formed as a pair with the left housing of the housing main body has screw holes formed thereon, and is fixed by a plurality of screws not illustrated.

In the cordless-type impact driver 1 according to the present embodiment, a power tool (an impact driver) without decreasing a tightening torque value by the output shaft 31 but with achieving significant downsizing and light weight can be achieved. In this manner, the power tool is easy to carry, and significantly facilitates working in a narrow location.

### Second Embodiment

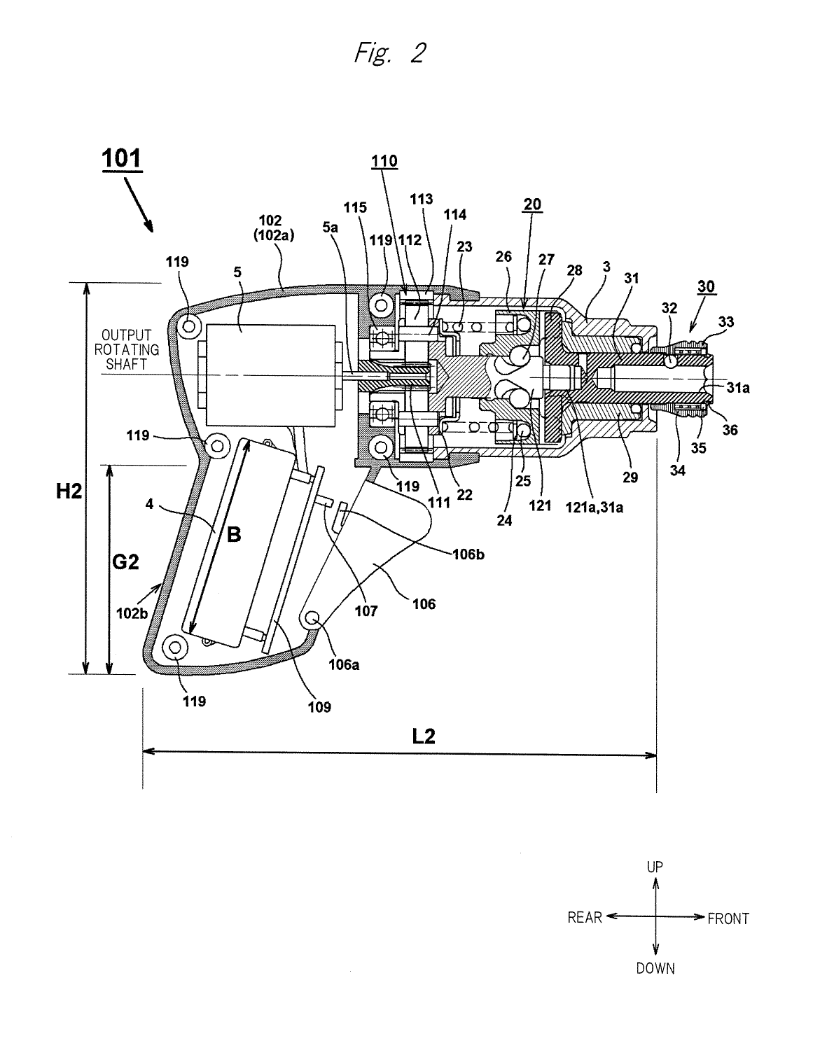

Next, a second embodiment is explained with reference to FIG. 2. For an impact driver 101 according to the second embodiment, an impact mechanism 20 which is basically similar to the impact mechanism 20 of the impact driver 1 according to the first embodiment is used. Also, a shape of a hammer case 3 illustrated in FIG. 2 is the same as that of the hammer case 3 illustrated in FIG. 1. However, a position at which the motor 5 is housed is different so that the motor 5 is arranged coaxially with the output shaft 31 to arrange the rotating shaft 5a and the output shaft 31 in series to each other. Therefore, the shape of the housing main body 102 is slightly different. While the fact that the shape is the substantially L shape in the side view is basically the same as that of the first embodiment, a speed-reduction mechanism 110 is a planet-gear-type speed-reduction mechanism including: a plurality of planet gears 112 that revolve around a pinion gear 111 attached to the rotating shaft 5a of the motor 5; and a ring gear 113 provided on an outer circumferential side of each of the planet gears 112. This speed-reduction mechanism 110 is configured as one-speed step change in the axial direction, and therefore, the length of the speed-reduction mechanism 110 in the axial direction can be shortened. A configuration of the spindle 121 holding the hammer 26 through the ball 27 is different from that of the first embodiment only in a rear end portion. The rear end portion of the spindle 121 functions as a planet carrier which pivotally supports a pin 114 serving as a rotating axis of each of three planet gears 112.

Below the motor 5 of the housing main body 102, a handle portion 102b with which the worker holds the impact driver 101 is formed. In an inner space of the handle portion, the battery 4 and a circuit board 109 are housed. Also, in an opening formed at the front of the handle portion 102b, a trigger 106 protruding forward from the opening and being rotatable around a swing shaft 106a by only a predetermined angle is provided. Inside the trigger 106, a press piece 106b is formed. When the trigger 106 is pulled, a switch 107 mounted on the circuit board 109 is pressed by the press piece 106b, so that the switch 107 is turned ON.

In the impact driver 101 of the second embodiment, the motor 5 is arranged coaxially with the output rotating shaft, and the rotating shat 105a and the output rotating shaft are arranged in series to each other. Therefore, a total length L2 of the impact driver 101 illustrated in FIG. 2 is slightly longer than the total length L1 of the impact driver 1 illustrated in FIG. 1. However, a total height H2 thereof illustrated in FIG. 2 is lower than the total height H1 thereof illustrated in FIG. 1. Therefore, a power tool (an impact driver) achieving significant downsizing and light weight can be achieved.

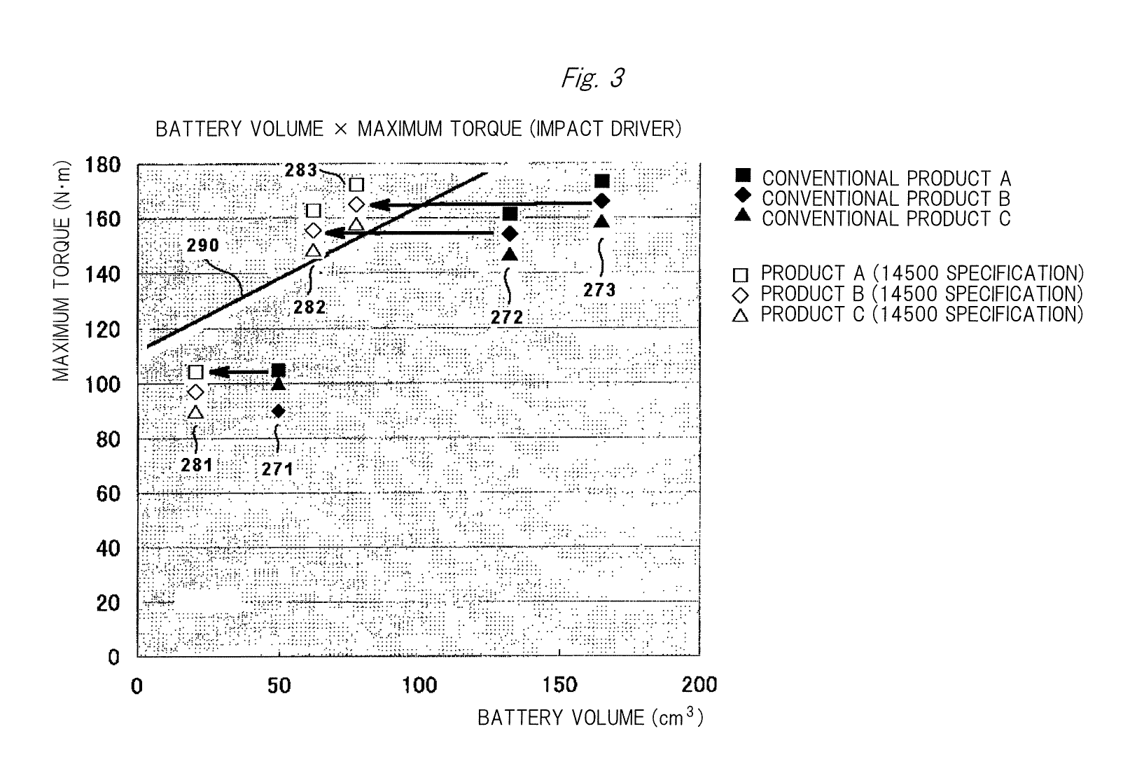

Next, a relation between the battery volume and the maximum torque of the power tool in each of the first and the second embodiments is explained with reference to FIG. 3. In a graph illustrated in FIG. 3, three power tools (Product A to Product C) each using a conventional 18650-size battery are plotted. Since the battery volume per one 18650-size battery is about 16.5 cm³, the battery volume of three batteries is 50.5 cm³, and therefore, the maximum torque of a three-battery specified power tool in a conventional technique is indicated by a numerical symbol “271” in the drawing. Similarly, the battery volume of eight batteries is 132.2 cm³, and therefore, the maximum torque of an eight-battery specified power tool in a conventional technique is indicated by a numerical symbol “272” in the drawing. Further, the battery volume of ten batteries is about 165 cm³, and therefore, the maximum torque of a ten-battery specified power tool in a conventional technique is indicated by a numerical symbol “273” in the drawing. It is tried to use the 14500-size battery as the conventionally-used battery instead of the 18650-size battery, and to achieve the equivalent maximum torque by improving the speed-reduction mechanism, a type of the motor, and others. Accordingly, the battery volume per one 14500-size battery is about 7.7 cm³, and therefore, is half or smaller than that in the conventional 18650-size battery in a volume ratio. Therefore, the battery volumes are changed from 271 to 281, from 272 to 282, and from 273 to 283 in the drawing. As described above, if a battery output (current value) equivalent to that of the conventional device can be achieved with using the 14500-size lithium ion battery, only the size of the power tool can be decreased without changing the output of the power tool, and therefore, the relation between the battery volume and the maximum torque may be set so as to, for example, be positioned upper than a straight line 290.

### Third Embodiment

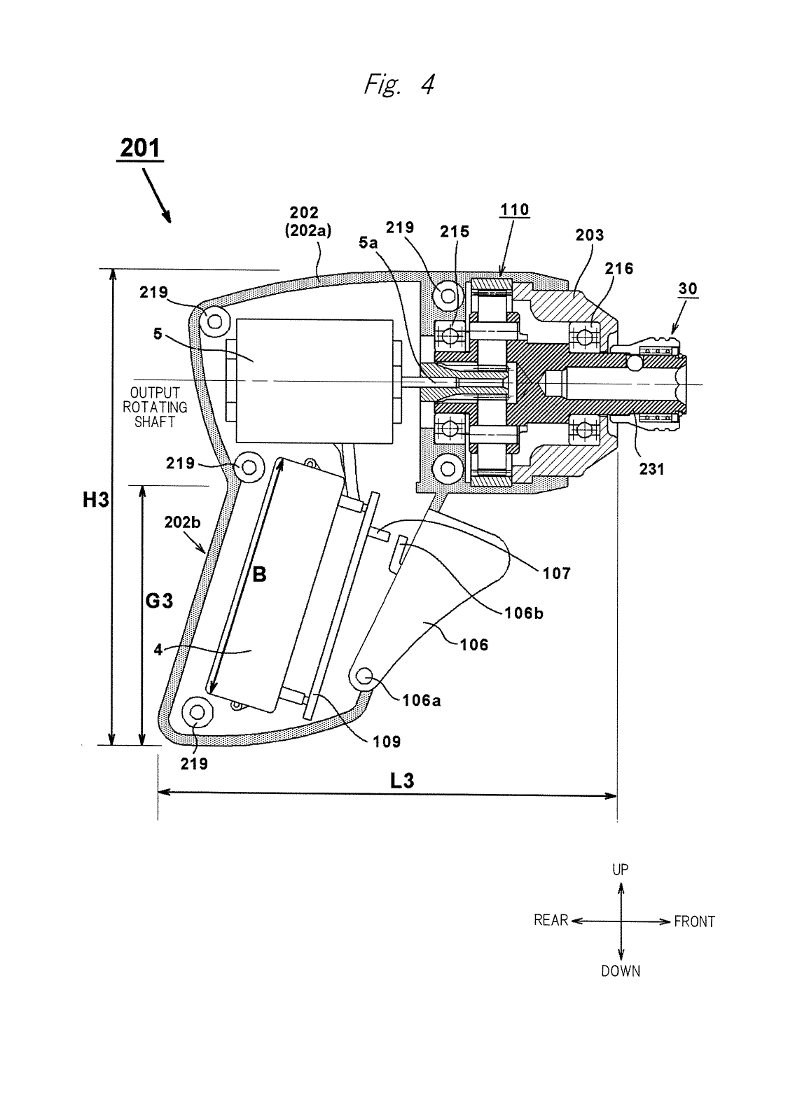

Next, a third embodiment is explained with reference to FIG. 4. As different from the power tools according to the first and second embodiments, a power tool according to the third embodiment is a driver drill 201 including a clutch mechanism (an electronic clutch) instead of the impact mechanism. The driver drill 201 illustrated in FIG. 4 includes a housing having a substantially L shape (or a gun-type shape) in a side view. The housing is configured of: a housing main body 202 made of polymer resin such as plastic; and a hammer case 3 having a cup shape which is attached so as to protrude frontward from a body portion 202a of the housing main body 202. In the driver drill 201, not a mechanical clutch mechanism but an electronic clutch mechanism is provided between the speed-reduction mechanism 110 and the attachment portion 30. The electronic clutch mechanism detects a magnitude of a reaction force (a torque value) caused from a tightening member and applied to a spindle 221 with using a current value flowing through a motor 205, and stops current supply to the motor 205 if the torque value exceeds a predetermined torque value so as to stop the rotation of the motor 205. In this manner, the front-side structure of the speed-reduction mechanism 110 of the planet-gear type is simplified because of the adoption of the electronic clutch mechanism, and therefore, a shape of a spindle case 203 manufactured by integrally molding a metal such as an aluminum alloy can be also downsized. Further, there is no mechanical element for the clutch mechanism provided on an outer circumferential side of an output shaft 231, and therefore, the output shaft 231 can be pivotally supported by using a large-sized ball bearing 216.

Below the motor 5 of the housing main body 202, a handle portion 202b with which the worker holds the driver drill 201 is formed. In an inner space of the handle portion, the battery 4 and the circuit board 109 which are basically the same components as those of the second embodiment are housed. Also, in an opening formed at the front of the handle portion 202b, the trigger 106 protruding frontward from the opening and being rotatable around the swing shaft 106a only by a predetermined angle is provided. Inside the trigger 106, the press piece 106b is formed. When the trigger 106 is pulled, the press piece 106b presses the switch 107 mounted on the circuit board 109, so that the switch 107 is turned ON. On the circuit board 109 of the present embodiment, note that an electronic circuit provided with a function serving as an electronic clutch control portion but not illustrated is mounted. The electronic clutch control portion may be achieved by using a publicly-known technique, and monitors a value of current flowing from the battery 4 to the motor 5 in the rotation driving, determines that the torque reaches a predetermined value if the value of the current flowing through the motor 5 is increased up to a predetermined value by the increase in the reaction force from the tightening member to the output shaft 231, and interrupts the current supplied to the motor 5 even in the state that the trigger 106 is pulled, so that the rotation of the motor 5 stops. After the rotation of the motor 5 stops, the worker returns the pulled trigger 106 to an original state, so that the tightening work ends. After the clutch mechanism acts to stop the rotation of the motor 5, the worker releases the holding of the trigger 106 once to return it to the original state, so that a next tightening work can be performed. The predetermined value of the current value can be arbitrarily increased and decreased by a button not illustrated or others, so that the tightening torque can be finely adjusted.

As described above, in the present embodiment, the size of the driver drill can be minimized, and the shape of the housing can be the substantially L shape in the side view so that a total length (front-to-rear length) L3 is equal to or shorter than 120 mm and a total height H3 is equal to or lower than 90 mm. Also, a height G3 of the handle portion 202b can be within almost the same length as a length B of the battery 4, and therefore, an extremely compact and light-weight driver drill can be achieved.

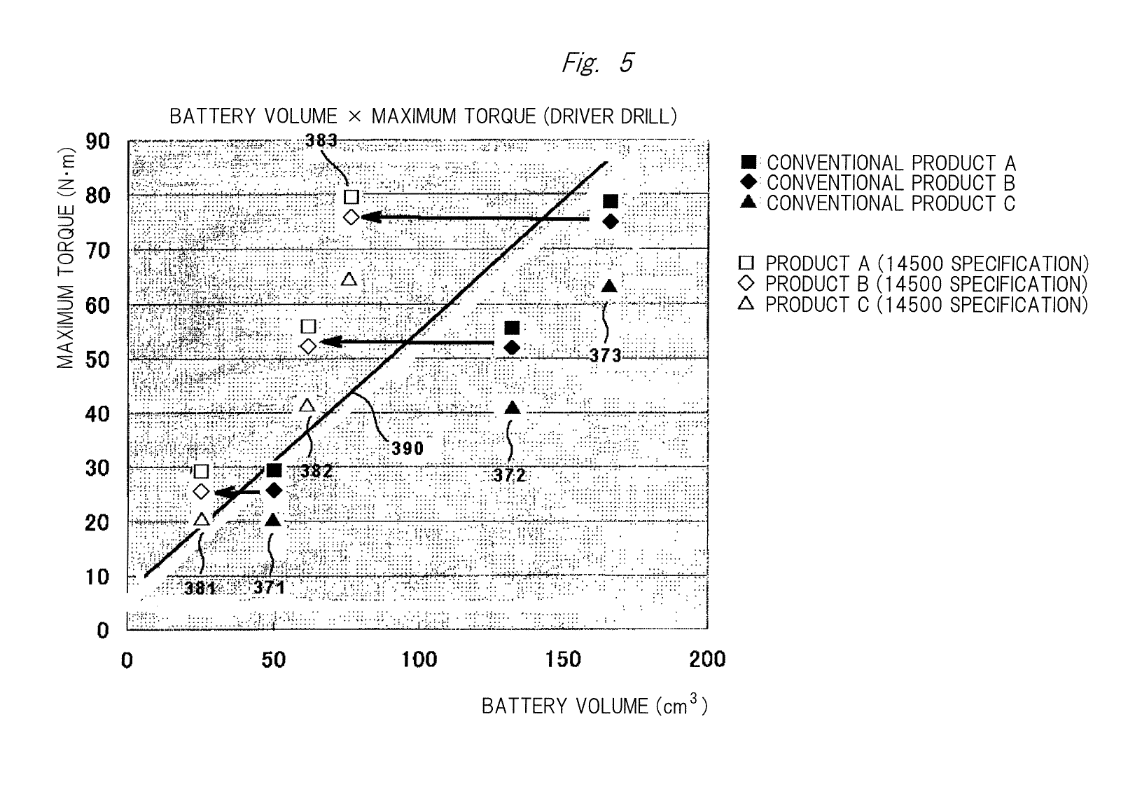

Next, a relation between the battery volume and the maximum torque in the power tool (driver drill) 201 is explained with reference to FIG. 5. When the conventional 18650-size battery is used, the battery volume per one battery is about 16.5 cm³, and therefore, one-battery specified battery volume is about 16.5 cm³, two-battery specified battery volume is about 33.0 cm³, three-battery specified battery volume is about 50.5 cm³, eight-battery specified battery volume is about 132.2 cm³, and ten-battery specified battery volume is about 165 cm³. If not the 18650-size battery but the 14500-size battery is used as this battery, the battery volume per one battery is half or smaller in a volume ratio because it decreases from about 16.5 cm³ to about 7.7 cm³. Therefore, if a battery output (current value) equivalent to that of the conventional device can be achieved with using the 14500-size lithium ion battery, only the size of the tool can be decreased with maintaining the output of the power tool. In FIG. 5, the maximum torque of a power tool using three of the conventional 18650-size batteries is indicated by a numerical symbol “371” in the drawing. Similarly, the maximum torque of a power tool using eight batteries is indicated by a numerical symbol “372” in the drawing, and the maximum torque of a power tool using ten batteries is indicated by a numerical symbol “373” in the drawing. Here, when it is tried to use the 14500-size battery as the battery instead of the 18650-size battery, and to achieve the equivalent maximum torque by improving the speed-reduction mechanism, a type of the motor, and others, the battery volumes are changed from 371 to 381, from 372 to 382, and from 373 to 383 in the drawing. As described above, if the battery output (current value) equivalent to that of the conventional device can be achieved with using the 14500-size lithium ion battery, only the size of the tool can be decreased without changing the output of the power tool, and therefore, the relation between the battery volume and the maximum torque may be set so as to, for example, be positioned upper than a straight line 390.

In the foregoing, the present invention has been concretely described based on the embodiments. However, it is needless to say that the present invention is not limited to the foregoing embodiments and various alterations can be made within the scope of the present invention. For example, in the embodiments, the examples of applying the present invention to an impact driver and a driver drill as the power tool have been explained. However, the present invention can be applied not only to the impact driver but also to a power tool of any mode using a 14500-size battery as a driving source.

1. A power tool comprising:
a housing including a body portion which houses a motor, and a handle portion extending downward from the body portion;
an output portion driven at front of the motor; and
a trigger switch which controls power supply from a battery to the motor,
the motor, the battery, and the trigger switch being arranged so as to overlap each other in an intersecting direction with respect to a front-and-rear direction.

2. The power tool according to claim 1,
wherein the battery and the trigger switch are arranged immediately below the motor inside the handle portion so as to be aligned in the front-and-rear direction.

3. The power tool according to claim 1,
wherein the housing is formed of a cylindrical body portion and a handle portion which are arranged so as to be coupled to each other in a substantially L shape in a side view.

4. The power tool according to claim 1,
wherein a length of the housing in the front-and-rear direction is equal to or shorter than 150 mm, and a length thereof in an up-and-down direction is equal to or shorter than 90 mm.

5. The power tool according to claim 4,
wherein the output portion includes: a speed-reduction mechanism which reduces a speed of rotation of the motor; and an output shaft which holds a tip tool and is rotated by the speed-reduction mechanism.

6. The power tool according to claim 1,
wherein the battery is a lithium ion secondary battery in which continuous discharge is allowed at a current value equal to or larger than 20 A and which has a diameter of 14 mm and a length of 50 mm.

7. The power tool according to claim 6,
wherein one or more of the lithium ion secondary batteries are housed in the handle portion.

8. The power tool according to claim 7,
wherein a rotating shaft of the motor is arranged coaxially with and in series to an output shaft of the output portion.

9. The power tool according to claim 7,
wherein a rotating shaft of the motor is arranged in parallel to the output shaft so that an axis line thereof is shifted from an output shaft of the output portion.
